(19) United States
(12) Patent Application Publication
(10) Pub. No.: US 2012/0068541 A1
(43) Pub. Date: Mar. 22, 2012

(54) POWER SUPPLY SYSTEMS AND METHODS EMPLOYING A UPS INTERFACED GENERATOR

(75) Inventor: Jason Scott Anderson, Raleigh, NC (US)

(73) Assignee: Eaton Corporation

(21) Appl. No.: 12/885,946

(22) Filed: Sep. 20, 2010

(51) Int. Cl. H02J 9/00

(52) U.S. Cl. 307/66

(57) ABSTRACT

An uninterruptible power supply (UPS) system includes a power transfer circuit having a power output configured to be coupled to a load, a UPS circuit having first power input configured to be coupled to a generator, such as a diesel- or gas-powered engine-generator set. The UPS circuit also has a second power input configured to be coupled to a backup power source, such as a battery or other energy storage device. The UPS circuit further has a power output configured to be coupled in common to the load with the power output of the power transfer circuit. The UPS system further includes a control circuit operatively associated with the UPS circuit and configured to control provision of power to the load from the generator and the backup power source via the UPS circuit responsive to a status of the power transfer circuit. The power transfer circuit may include, for example, another UPS circuit or other power transfer device, such as a static switch.

### BACKGROUND

The inventive subject matter relates to power supply systems and methods and, more particularly, to uninterruptible power supply (UPS) systems and methods.

UPS systems are commonly used in installations such as data centers, medical centers and industrial facilities. UPS systems may be used in such installations to provide backup power to maintain operation of computer, medical devices and other critical equipment in event of failure of a primary utility supply. These UPS systems commonly have an “on-line” configuration including a rectifier and inverter coupled by a DC link that is also coupled to a backup power source, such as a battery. Other UPS configurations may also be used, such as standby and line-interactive configurations.

In some applications, such as data centers, a local generator, such as diesel- or gas-powered engine-generator set, may be used to provide backup power in the event of the failure of a utility source. Such systems commonly use an automatic transfer switch (ATS) to transfer the load between the utility source and the local generator. UPSs may be used in conjunction with a local generator, as described, for example, in U.S. Pat. No. 7,723,863 to Johnson et al., U.S. Pat. No. 7,635,967 to Loucks et al. and U.S. Pat. No. 7,566,990 to Loucks et al.

### SUMMARY OF THE INVENTIVE SUBJECT MATTER

Some embodiments of the inventive subject matter provide an uninterruptible power supply (UPS) system including a power transfer circuit having a power output configured to be coupled to a load, a UPS circuit having first power input configured to be coupled to a generator, such as a diesel- or gas-powered engine-generator set. The UPS circuit also has a second power input configured to be coupled to a backup power source, such as a battery or other energy storage device. The UPS circuit further has a power output configured to be coupled in common to the load with the power output of the power transfer circuit. The UPS system further includes a control circuit operatively associated with the UPS circuit and configured to control provision of power to the load from the generator and the backup power source via the UPS circuit responsive to a status of the power transfer circuit. The power transfer circuit may include, for example, another UPS circuit or other power transfer device, such as a static switch.

In some embodiments, the control circuit may be configured to cause the UPS circuit to sequentially provide power to the load from the backup power source and the generator responsive to a failure of the power transfer circuit and/or a power source coupled to a power input of the power transfer circuit. For example, the control circuit may be configured to activate the generator and to cause the UPS circuit to provide power to the load from the backup power source until the generator is available to support the load.

In further embodiments, the control circuit may be configured to cause the power transfer circuit and the UPS circuit to concurrently provide power to the load from the generator and from a power source coupled to the power input of the power transfer circuit. Such operations may advantageously support maintenance and testing operations.

In some embodiments, the UPS circuit includes a first converter circuit coupled to the first power input, a second converter circuit coupled to the power output and a DC link coupled to the second power input and coupling the first and second converter circuits. The UPS circuit may further include a switch configured to couple and decouple an output of the second converter circuit to and from the load. The control circuit may be configured to cause the switch to couple the output of the second converter circuit to the load while the second converter circuit is inactive and the power transfer circuit is providing power to the load. The control circuit may be further configured to activate the second converter circuit responsive to a failure of the power transfer circuit and/or a power source coupled to a power input of the power transfer circuit without changing a state of the switch. The second converter circuit may be configured to pass a charging current to the backup power source while the inverter circuit is inactive and the power transfer circuit is providing power to the load.

In some embodiments, the UPS circuit includes a first UPS circuit and the power transfer circuit includes a second UPS circuit. The first and second UPS circuits may include parallel-connected power conversion modules. In further embodiments, the power transfer circuit may include a static switch.

Further embodiments of the inventive subject matter provide a UPS system including a UPS circuit having a first power input configured to be coupled to a generator, a second power input configured to be coupled to a backup power source and a power output configured to be coupled to a load. The UPS circuit includes a rectifier circuit coupled to the first power input, an inverter circuit coupled to the power output and a DC bus coupled to the second power input and coupling an output of the rectifier circuit to an input of the inverter circuit. The system further includes a control circuit operatively associated with the UPS circuit and configured to control provision of power to the load from the generator and the backup power source via the UPS circuit responsive to a status of a power source, such as a utility source and/or intervening devices, coupled to the load. The control circuit may be configured to cause the UPS circuit to sequentially provide power to the load from the backup power source and the generator responsive to a failure of the power source.

In some method embodiments, power is selectively provided to a load from a generator and a backup power source via a UPS circuit responsive to a status of another power source coupled to the load. The UPS circuit may include a rectifier circuit having an input configured to be coupled to the generator, an inverter circuit having an output configured to be coupled to the load and a DC bus coupling the rectifier circuit and the inverter circuit and configured to be coupled to the backup power source.

### BRIEF DESCRIPTION OF THE DRAWINGS

FIG. 1 is a schematic diagram illustrating a UPS system according to some embodiments of the inventive subject matter.

FIG. 2 is a schematic diagram illustrating a UPS system according to further embodiments of the inventive subject matter.

FIGS. 3 and 4 are flowcharts illustrating operations of a UPS system according to some embodiments of the inventive subject matter.

FIG. 5 is a schematic diagram illustrating a modular UPS system according to some embodiment of the inventive subject matter.

FIG. 6 is a schematic diagram illustrating portions of a power conversion module of the UPS system of FIG. 5.

FIG. 7 is a schematic diagram illustrating a UPS system according to additional embodiments of the inventive subject matter.

FIG. 8 is a schematic diagram illustrating a modular UPS system according to further embodiments of the inventive subject matter.

### DETAILED DESCRIPTION OF EXEMPLARY EMBODIMENTS

Specific exemplary embodiments of the inventive subject matter now will be described with reference to the accompanying drawings. This inventive subject matter may, however, be embodied in many different forms and should not be construed as limited to the embodiments set forth herein; rather, these embodiments are provided so that this disclosure will be thorough and complete, and will fully convey the scope of the inventive subject matter to those skilled in the art. In the drawings, like numbers refer to like elements. It will be understood that when an element is referred to as being “connected” or “coupled” to another element, it can be directly connected or coupled to the other element or intervening elements may be present. As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless expressly stated otherwise. It will be further understood that the terms “includes,” “comprises,” “including” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the specification and the relevant art and will not be interpreted in an idealized or overly formal sense unless expressly so defined herein.

As will be appreciated by one of skill in the art, the inventive subject matter may be embodied as systems, methods and computer program products. Some embodiments of the inventive subject matter may include hardware and/or combinations of hardware and software. Some embodiments of the inventive subject matter include circuitry configured to provide functions described herein. It will be appreciated that such circuitry may include analog circuits, digital circuits, and combinations of analog and digital circuits.

Embodiments of the inventive subject matter are described below with reference to block diagrams and/or operational illustrations of systems and methods according to various embodiments of the inventive subject matter. It will be understood that each block of the block diagrams and/or operational illustrations, and combinations of blocks in the block diagrams and/or operational illustrations, can be implemented by analog and/or digital hardware, and/or computer program instructions. These computer program instructions may be provided to a processor of a general purpose computer, special purpose computer, ASIC, and/or other programmable data processing apparatus, such that the instructions, which execute via the processor of the computer and/or other programmable data processing apparatus, create means for implementing the functions/acts specified in the block diagrams and/or operational illustrations. In some implementations, the functions/acts noted in the figures may occur out of the order noted in the block diagrams and/or operational illustrations. For example, two operations shown as occurring in succession may, in fact, be executed substantially concurrently or the operations may sometimes be executed in the reverse order, depending upon the functionality/acts involved.

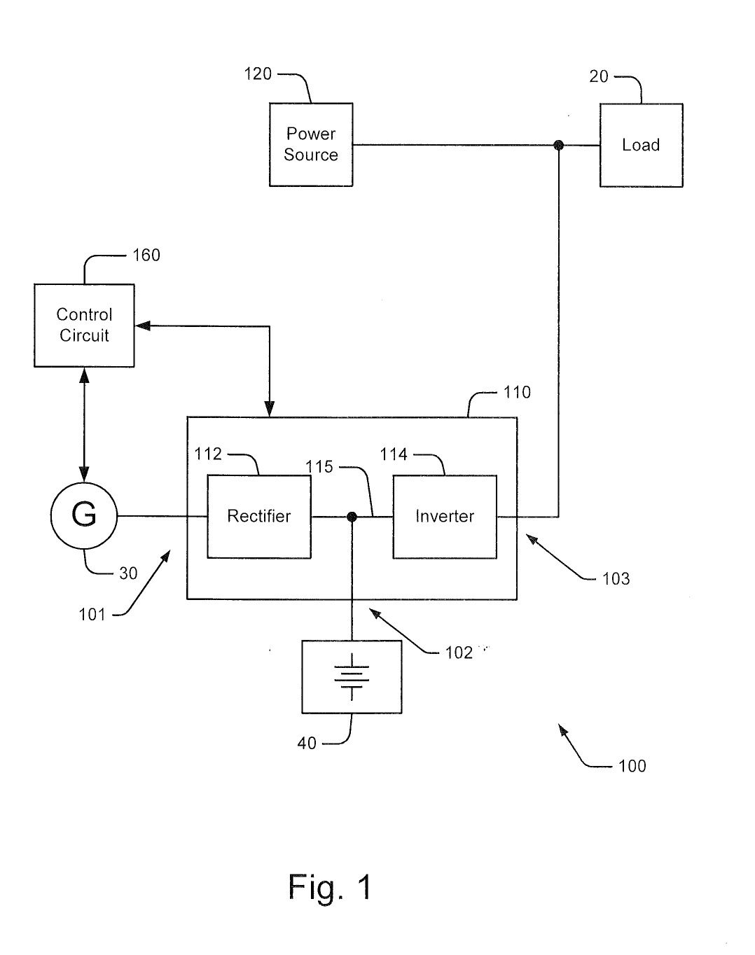

FIG. 1 illustrates an uninterruptible power supply (UPS) system 100 according to some embodiments. The system 100 includes a UPS circuit 110 having an output coupled to a load 20, in parallel with another power source 120, e.g., a utility source, another generator, another UPS circuit, etc. The UPS circuit 110 has a first input 101 configured to be coupled to a generator 30 and a second input 102 configured to be coupled to a backup power source, which may comprise a battery 40 as illustrated, and/or other types of energy storage devices, such as capacitors, flywheels, fuel cells and the like. In embodiments described herein, the generator 30 may generally be used to provide longer-term back up power for the load 20, with the backup battery 40 being used to provide a temporary “bridging” power source until the generator 30 is available, for example, until the generator 30 has started and reached appropriate terminal characteristics (e.g., voltage and phase). The generator 30 may comprise, for example, a diesel- or gas-powered engine-generator set and/or a device with similar capabilities, such as a microturbine or fuel cell.

In the illustrated embodiments, the UPS circuit 110 includes a rectifier circuit 112 coupled to the first input 101, an inverter 114 coupled to the output 103 and a DC link 115 which couples the output of the rectifier circuit 112 to the input of the inverter circuit 114 and which is also coupled to the second input 102. It will be appreciated that the DC link 115 may be directly coupled to the battery 40, or may be coupled via intervening conversion circuitry, such as a DC/DC converter circuit. A control circuit 160 is operatively associated with the UPS circuit 110 and the generator 30, and is configured to control interactions thereof.

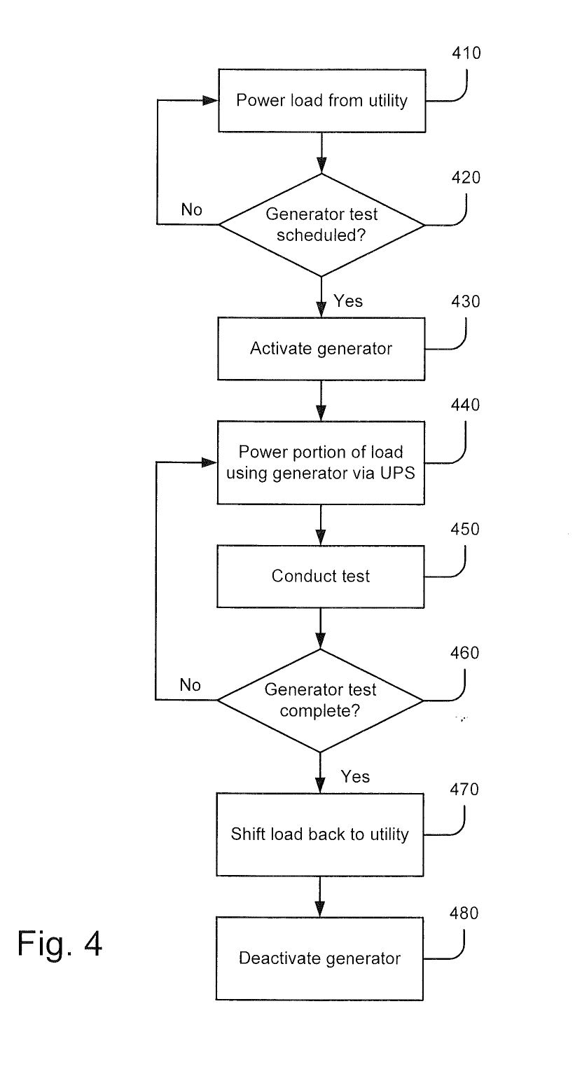

The UPS circuit 110 may be configured to selectively provide power to a load 20 coupled to an output 103 from the generator 30 and the battery 40. For example, in a first mode of operation, power generated by the generator 30 may be passed through the rectifier circuit 112 and the inverter circuit 114 to the load 20. In a second mode of operation, e.g., when the generator 30 is not active or available, power may be passed from the battery 40 to the load 20 via the inverter circuit 114. According to some embodiments of the inventive subject matter, these modes may be selectively entered responsive to the state of the other power source 120 to provide a seamless transition to generator-powered operation, as explained in greater detail below with reference to FIG. 4. In further embodiments, the configuration shown may also be advantageously used to enable testing of the generator 30 under load while maintaining seamless service to the load 20.

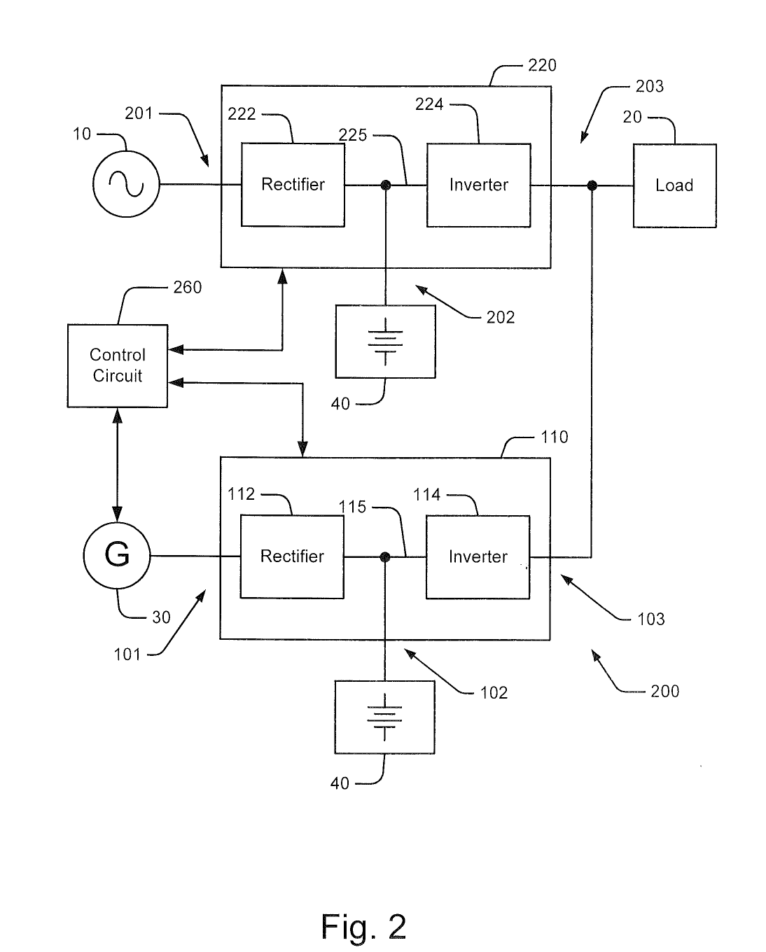

FIG. 2 illustrates a UPS system 200 according to further embodiments of the inventive subject matter. The system 200 includes a first UPS circuit 110 having a first input 101 configured to be coupled to a generator 30, a second input 102 configured to be coupled to a battery 40 and an output 103 configured to be coupled to a load 20 along the lines discussed above with reference to FIG. 1. Another power source is coupled to the load 20 in the form of a second UPS circuit 220, which has a first input 201 configured to be coupled to a utility source 10, a second input 202 configured to be coupled to a battery 40 (which may be the same battery as that used by the first UPS circuit 110 or a different battery) and an output 203 configured to be coupled to the load 20. The second UPS circuit 220 may have an online configuration similar to that of the first UPS circuit 110, including a rectifier circuit 222, inverter circuit 224 and DC link 225, which may be configured similarly to the rectifier circuit 112, inverter circuit 114 and DC line 115 of the first UPS 110. Alternatively, the second UPS 220 may have a different configuration, such as a standby or line-interactive configuration. A bypass circuit (not shown) may also be provided to support direct coupling of the utility source 10 to the load 20 via a semiconductor or other switch.

A control circuit 260 is configured to control interoperation of the first UPS circuit 110, the second UPS circuit 220 and the generator 30. In some embodiments, the control circuit 260 is configured to control provision of power to the load 20 from the generator 30 and the battery 40 via the first UPS circuit 110 responsive to a status of the second UPS circuit 220. For example, if the utility source 10 coupled to the first input of the second UPS circuit 220 fails, the first UPS circuit 110 may cause the first UPS circuit 110 to sequentially provide power to the load 20 from the battery 40 and the generator 10 such that the load 20 may be eventually served from the generator 30 until such time that the utility source 10 is re-established. Similarly, if the second UPS circuit 220 suffers an internal failure that prevents delivery of power from the utility source 10 to the load 20, the first UPS circuit 110 may sequentially provide power to the load 20 from the battery 40 and the generator 10 such that generator 30 eventually may power the load 20 until the fault is cleared and/or a bypass (not shown) of the second UPS circuit 220 is established. In further embodiments, the control circuit 260 may be configured to control the first UPS circuit 110, the second UPS circuit 220 and the generator 30 to support testing of the generator 30 under load by transferring at least a portion of the load 20 to the generator 30.

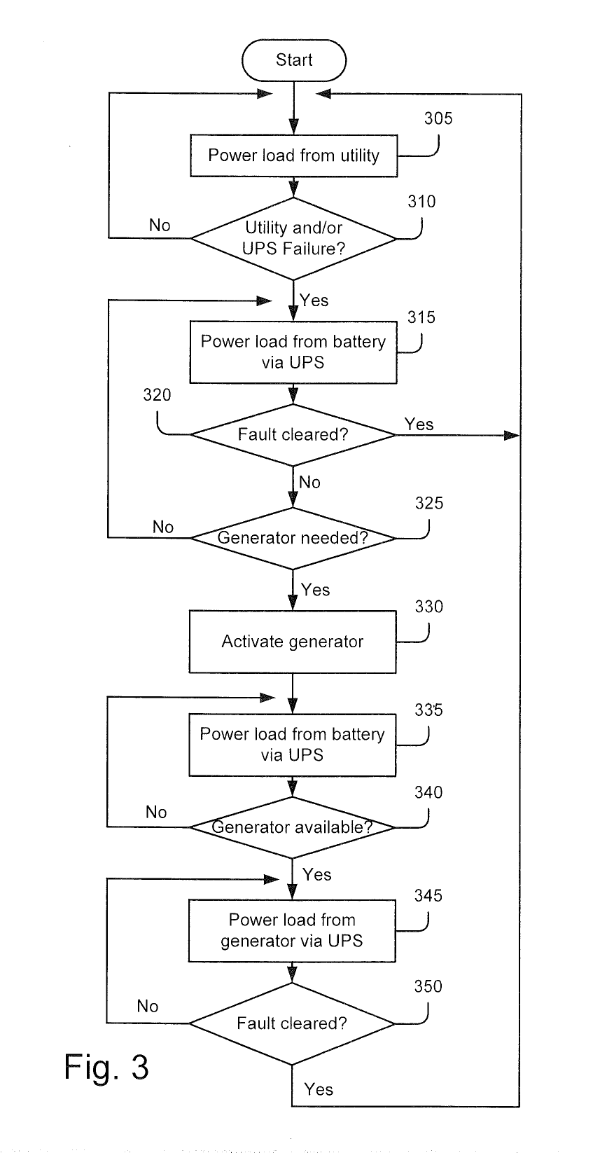

FIG. 3 illustrates operations for transitioning to generator powered operation upon failure of the utility source 10 and/or the second UPS circuit 220. Initially, the load 20 is powered from the utility source 10 via the second UPS circuit 220, or by a bypass circuit coupled between the utility source 10 and the load 20 (block 305). If a failure of the utility source 10 and/or the second UPS circuit 220 is detected, the control circuit 260 transfers at least a portion of the load 20 to the battery 40 coupled to the first UPS circuit 110 (blocks 310, 315). If the fault clears in a sufficiently short time, the transferred portion of the load 20 may be transferred back to the utility source 10 (blocks 320, 305). If the fault persists for a sufficiently long time, the generator 30 may be started and begin transitioning to an operational state, e.g., an appropriate output voltage and phase, while the battery 40 continues to supply power via the first UPS circuit 110 (blocks 325, 330, 335). Under some conditions, for example, if the failure is of the utility source 10 and not the second UPS circuit 220, power may also be provided to the load 20 via the battery 40 coupled to the second UPS circuit 220. In various configurations, the same battery may be coupled to both the first and second UPS circuits 110, 220 or separate batteries may be used for each. Once the generator 30 becomes available, e.g., once its terminal characteristics meet a predetermined criterion, at least a portion of the load 20 may be transferred to the generator 30 such that it delivers power to the load 20 via the first UPS circuit 110 (blocks 340, 345). If the fault clears, the load 20 may be transitioned back to the utility source 10 (blocks 350, 305). In this manner, the generator 30 may be used to provide longterm backup, with the battery 40 providing short-term and/or interim backup power.

It will be appreciated that the operations illustrated in FIG. 3 may be varied and/or supplemented with other operations. For example, the control circuit 260 may be configured to receive information that allows it to determine a likely duration of the utility source 10. If such information indicates that an outage is likely to be of short duration, the control circuit 260 may decide to forego use of the generator 30 (e.g., for likely short duration outages) or to delay start of the generator 30 to allow for a fault to clear. If such information indicates a lengthy potential outage, the control circuit 260 may transition to the generator 30 as quickly as possible to conserve energy stored in the battery 40, which may transition to being a backup source for the generator 30.

FIG. 4 illustrates operations of the system 200 of FIG. 2 for supporting generator testing according to further embodiments. Initially, Initially, the load 20 is powered from the utility source 10 via the second UPS circuit 220, or by a bypass circuit (not shown) coupled between the utility source 10 and the load 20 (block 410). If a generator test is due, the control circuit 260 activates the generator 30 and causes at least a portion of the load to be transferred to the generator 30 (blocks 420, 430, 440). Such load sharing may be achieved, for example, by varying a phase reference of inverter circuit 110 of the first UPS circuit 110 to cause current to flow from the first UPS circuit 110 to the load 20. Under this condition, operation of the generator 30 may be tested, which may entail simply running the generator 30 under load or running the generator 30 under load while testing certain operating parameters of the generator 30 (block 450). Once the test is complete, the load 20 may be shifted back to the utility source 10 and the generator 30 deactivated (blocks 460, 470, 480). In this manner, the generator 30 may be tested under load, which may provide a more accurate assessment of its status and may be more conducive to generator health than operating with no load.

It will be appreciated that similar techniques may be used to support maintenance operations. For example, in preparation for maintenance of the second UPS circuit 220 and/or other equipment (e.g., a static bypass switch) associated therewith, the generator 30 may be brought online to take over provision of power to the load 20 and allow de-energizing of the second UPS circuit 220 and associated equipment.

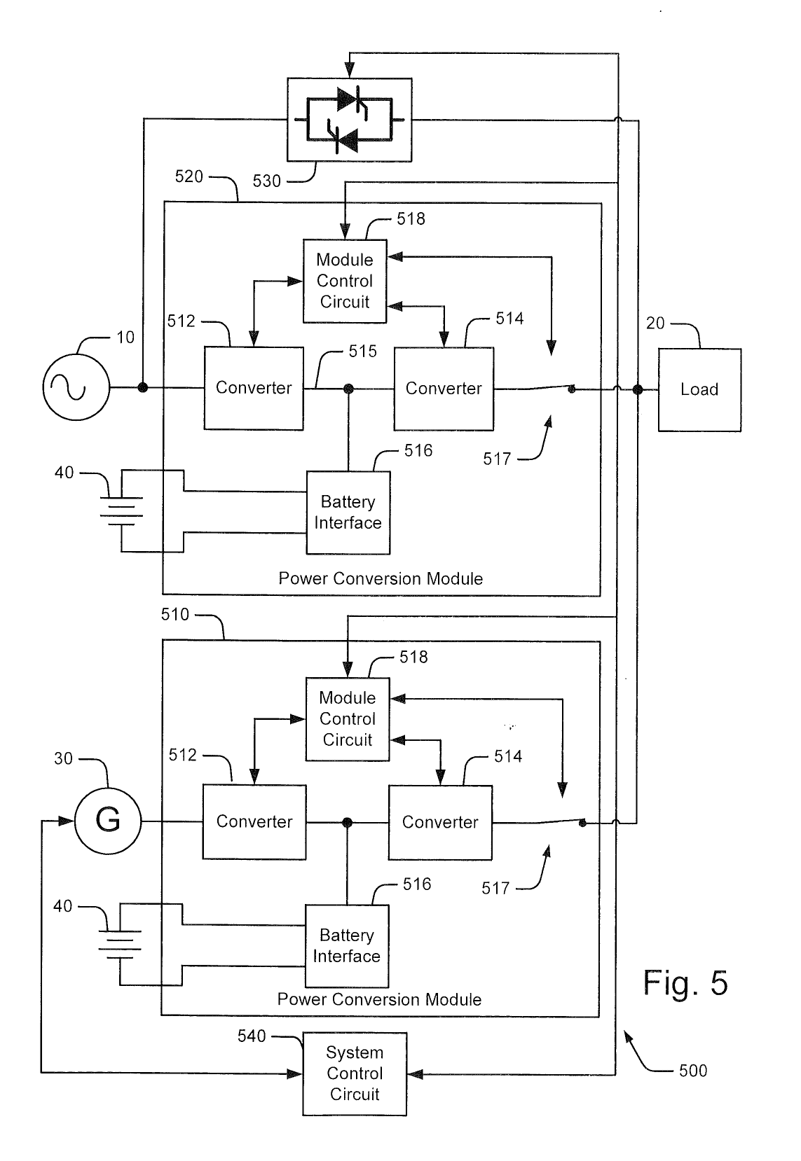

FIG. 5 illustrates a modular UPS system 500 according to further embodiments of the inventive subject matter. The UPS system 500 includes first and second power conversion modules 510, 520. The first and second power conversion modules 510, 520 have a common architecture including first and second converter units 512, 514 linked by a DC bus 515, a battery interface unit 516 for coupling a battery to the DC bus 515 and an output switch (e.g., a contactor) 517 configured to couple and decouple the second converter to and from an output 503. The DC busses 515 of the modules 510, 520 may be independent, or the modules 510, 520 may share a common DC bus 515, external and/or internal to the modules 510, 520. A module control unit 518 controls operations of the first and second converter circuits 512, 514 and the output switch 517. The module control units 518 may be operatively associated with a system control circuit 540 that, for example, collectively controls operations of the power conversion modules 510, 520 in various operating modes.

The first and second converter circuits 512, 514 may include, for example, active half-bridge circuits that support four-quadrant operation as described, for example, in U.S. Pat. No. 7,088,601 to Tracy et al. It will be appreciated that the first and second converter circuits 512, 514 may be single- or multi-phase.

The modules 510, 520 may have the same or different form factors and/or capacities. For example, the modules 510, 520 may have a common form factor and/or external connection configuration, and may be designed to be interchangeably installed in a system chassis. Although two modules 510, 520 are illustrated, three or more such modules may be included in a UPS system, which modules being connected in parallel to provide desired capacity and/or redundancy.

The second power conversion module 520 is configured to provide on-line UPS operation, with power being selectively supplied to a load 20 from a utility source 10 and one or more backup batteries 40. The first converter circuit 512 of the second module 520 may be configured to provide rectification of the output of the utility source 10 to produce a DC voltage on the DC bus 515, and the second converter circuit 514 may be configured to act as an inverter, producing an AC voltage from the DC voltage on the DC bus 515 to power a load 20. The battery interface circuit 516 may provide a direct connection to the battery 40 and/or may function as a DC/DC converter that provides voltage conversion between the DC bus 515 and the battery 40. A bypass circuit 530 may also be provided to support bypass of the second power conversion module 520 under control, for example, of the system control circuit 540.

The first power conversion module 510 is configured to provide an interface for a generator 30, for example, a diesel or gas-powered engine-generator set. In particular, the first converter unit 512 of the first power conversion module 510 may be configured to provide rectification of an AC output of the generator 30, producing a DC voltage on the DC bus 515 from which the second converter circuit 514, acting as an inverter, produces an AC output. The battery interface circuit 516 of the first power conversion module 510 may be similar to the battery interface circuit 516 of the second power conversion module 520. The battery 40 connected to the first power conversion module 510 may be a separate battery or may be shared with the second power conversion module 520.

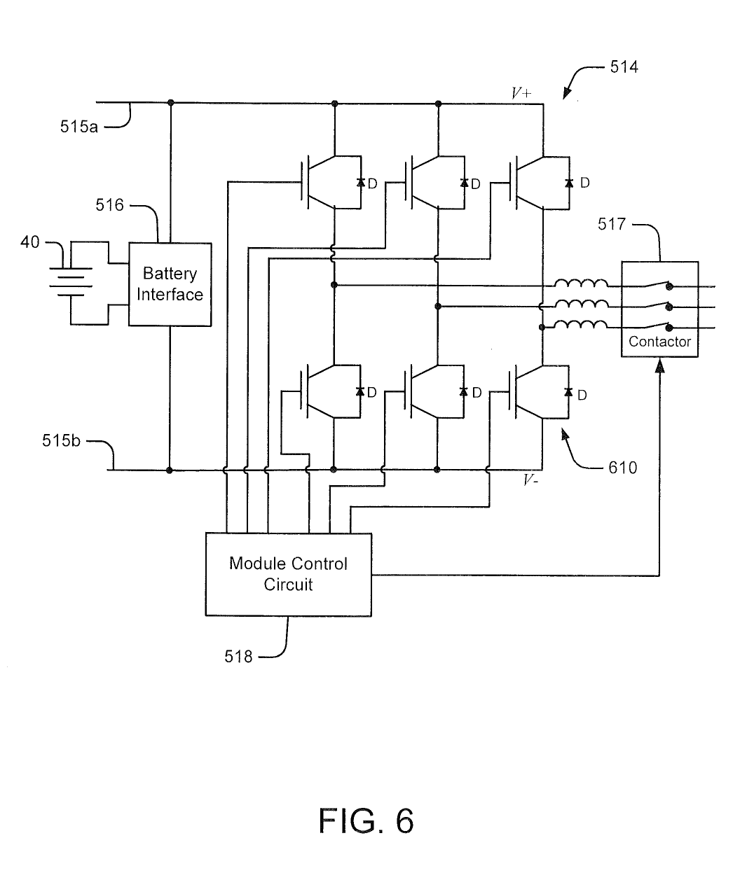

The first and second converter units 512, 514 of the first and second power conversion modules 510, 520 may include respective active bridge circuits that provide rectifier or inverter operations responsive to control signals applied thereto by the module control units 518. For example, as illustrated in FIG. 6, the second converter circuit 514 may be a three-phase converter circuit including three half-bridge transistor circuits coupled between a positive DC bus 515a and a negative DC bus 515b. The output switch 517 may include a three-phase contactor. The module control circuit 518 may be configured to drive the transistors of the half-bridge circuits.

Referring to FIG. 6 in conjunction with FIG. 5, while the second power conversion module 520 or the bypass circuit 530 is transferring power to the load 20 from the utility source 10, the module control circuit 518 of the first power conversion module 510 may maintain the output switch 517 in a closed position while deactivating the second converter circuit 514 by turning off the transistors of the half-bridge circuits, thus placing the second converter circuit 514 of the first power conversion module 510 into a “suspended” state. In this state, charging currents may pass to the battery 40 via the flyback diodes D of the half-bridge circuits of the second converter circuit 514 to allow charging of the battery 40 without requiring active operation of the second converter circuit 514. Upon failure of the utility source 10 and/or the second power conversion module 520, the module control circuit 518 of the first power conversion module 510 may quickly commence operating the second converter circuit 514 thereof as an inverter without having to first close the output switch 517, thus allowing power to be quickly supplied to the load 20 from the battery 40. Contemporaneously, the generator 30 may be activated and brought up to speed, with the generator 30 eventually supplanting the battery 40 in providing power to the load 20.

In some embodiments, the module control circuit 518 of the first power conversion module 510 may autonomously determine when to exit the “suspended” state and commence operation of the second converter circuit 514 as described above. In particular, by keeping the output switch 517 closed in the “suspended” state, the module control circuit 518 may be able to monitor the voltage being applied to the load 20 and react thereto without input from another control circuit, such as the system control circuit 540.

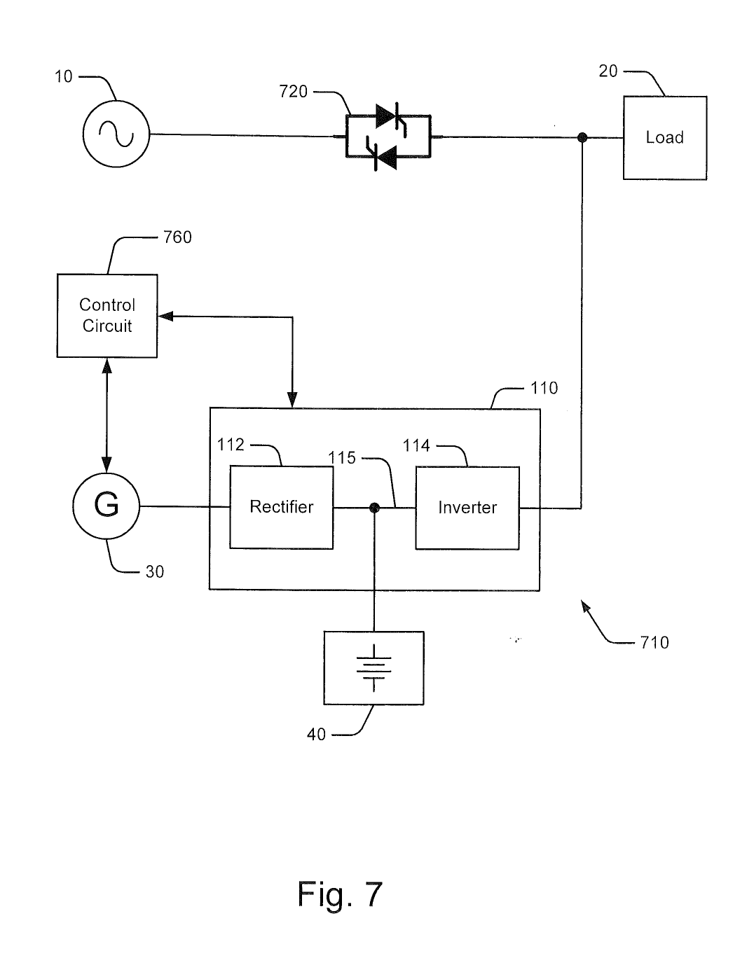

According to further embodiments of the inventive subject matter, a UPS-interfaced generator may be used in conjunction with a power transfer circuit other than another UPS. For example, as shown in FIG. 7, a UPS system 710 may include a UPS circuit 110 having an output coupled to a load 20, in parallel with a static transfer switch 720 that couples and decouples the load 20 from a utility source 10, and a control circuit 760 that controls operations of the UPS circuit 110 and a generator 30. The UPS circuit 110 has a first input 101 configured to be coupled to the generator 30 and a second input 102 configured to be coupled to a backup power source, here illustrated as a battery 40. The UPS circuit 110 includes a rectifier circuit 11, an inverter circuit 114, a DC link 115 and a control circuit 160, which may operate along lines described above with reference to FIG. 1. The UPS circuit 110 may be configured to selectively provide power to the load 20 from the generator 30 and the battery 40. For example, in a first mode of operation, power generated by the generator 30 may be passed through the rectifier circuit 112 and the inverter circuit 114 to the load 20. Upon failure of the utility source 10 and/or the static switch 720, the UPS circuit 110 may sequentially provide backup power to the load 10 from the battery 40 and the generator 30 along the lines described above.

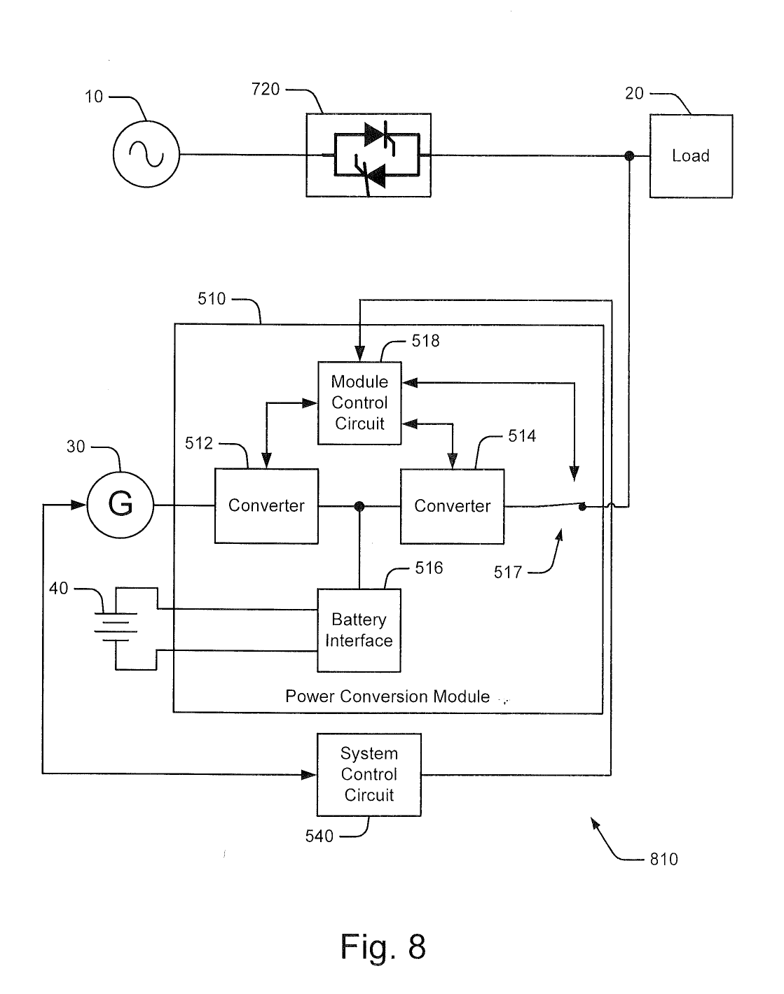

Such an arrangement may also be provided in a modular form, as illustrated in FIG. 8. As shown, a modular UPS system 810 may include at least one power conversion module 510, which may operate along the lines discussed above with reference to FIG. 5. The power conversion module 510 may be used to provide backup power to a load 20 from a battery 40 and a generator 30 upon failure of a utility source 10 and/or a static switch 720. It will be appreciated that one or more of such modules may be used, e.g., multiple modules may be connected in parallel between the generator 30 and the load 20 to provide a desired capacity.

In the drawings and specification, there have been disclosed exemplary embodiments of the inventive subject matter. Although specific terms are employed, they are used in a generic and descriptive sense only and not for purposes of limitation, the scope of the inventive subject matter being defined by the following claims.

That which is claimed:

1. An uninterruptible power supply (UPS) system comprising:
a power transfer circuit having a power output configured to be coupled to a load;
a UPS circuit having first power input configured to be coupled to a generator, a second power input configured to be coupled to a backup power source and a power output configured to be coupled in common to the load with the power output of the power transfer circuit; and
a control circuit operatively associated with the UPS circuit and configured to control provision of power to the load from the generator and the backup power source via the UPS circuit responsive to a status of the power transfer circuit.

2. The system of claim 1, wherein the control circuit is configured to cause the UPS circuit to sequentially provide power to the load from the backup power source and the generator responsive to a failure of the power transfer circuit and/or a power source coupled to a power input of the power transfer circuit.

3. The system of claim 2, wherein the control circuit is configured to activate the generator and to cause the UPS circuit to provide power to the load from the backup power source until the generator is available to support the load.

4. The system of claim 1, wherein the control circuit is further configured to cause the power transfer circuit and the UPS circuit to concurrently provide power to the load from the generator and from a power source coupled to the power input of the power transfer circuit.

5. The system of claim 1, wherein the UPS circuit comprises:
a first converter circuit coupled to the first power input;
a second converter circuit coupled to the power output; and
a DC link coupled to the second power input and coupling the first and second converter circuits.

6. The system of claim 5, wherein the UPS circuit comprises a switch configured to couple and decouple an output of the second converter circuit to and from the load and wherein the control circuit is configured to cause the switch to couple the output of the second converter circuit to the load while the second converter circuit is inactive and the power transfer circuit is providing power to the load.

7. The system of claim 6, wherein the control circuit is further configured to activate the second converter circuit responsive to a failure of the power transfer circuit and/or a power source coupled to a power input of the power transfer circuit without changing a state of the switch.

8. The system of claim 6, wherein the second converter circuit is configured to pass a charging current to the backup power source while the inverter circuit is inactive and the power transfer circuit is providing power to the load.

9. The system of claim 1, wherein the UPS circuit comprises a first UPS circuit and wherein the power transfer circuit comprises a second UPS circuit.

10. The system of claim 9, wherein the first and second UPS circuits comprise parallel-connected power conversion modules.

11. The system of claim 1, wherein the power transfer circuit comprises a static switch.

12. A UPS system comprising:
a UPS circuit having a first power input configured to be coupled to a generator, a second power input configured to be coupled to a backup power source and a power output configured to be coupled to a load, the UPS circuit comprising:
a rectifier circuit coupled to the first power input;
an inverter circuit coupled to the power output; and
a DC bus coupled to the second power input and coupling an output of the rectifier circuit to an input of the inverter circuit; and
a control circuit operatively associated with the UPS circuit and configured to control provision of power to the load from the generator and the backup power source via the UPS circuit responsive to a status of a power source coupled to the load.

13. The system of claim 12, wherein the UPS circuit comprises a first UPS circuit and wherein the power source comprises a second UPS circuit.

14. The system of claim 13, wherein the status comprises a status of the second UPS circuit and/or a utility power source coupled thereto.

15. The system of claim 12, wherein the power source comprises a static switch having an output coupled to the load.

16. The system of claim 15, wherein the status comprises a status of the static switch and/or a utility power source coupled thereto.

17. The system of claim 12, wherein the control circuit is configured to cause the UPS circuit to sequentially provide power to the load from the backup power source and the generator responsive to a failure of the power source.

18. The system of claim 17, wherein the control circuit is configured to activate the generator and to cause the UPS circuit to provide power to the load from the backup power source until the generator is available to support the load.

19. The system of claim 12, wherein the control circuit is further configured to cause the UPS circuit to concurrently provide power to the load from the generator and the power source.

20. The system of claim 1, wherein the UPS circuit comprises one or more parallel-connected power conversion modules.

21. A method of operating a UPS system, the method comprising:
selectively providing power to a load from a generator and a backup power source via a UPS circuit responsive to a status of a power source also coupled to the load.

22. The method of claim 20, wherein the UPS circuit comprises a rectifier circuit having an input configured to be coupled to the generator, an inverter circuit having an output configured to be coupled to the load and a DC bus coupling the rectifier circuit and the inverter circuit and configured to be coupled to the backup power source.

23. The method of claim 20, further comprising sequentially providing power to the load from the backup power source and the generator via the UPS circuit responsive to a failure of the power source.

24. The method of claim 23, further comprising providing power to the load from the backup power source until the generator is available to support the load.

25. The method of claim 21, further comprising concurrently providing power to the load from the generator and the power source.
